(19) United States
(12) Patent Application Publication
(10) Pub. No.: US 2009/0079804 A1
(43) Pub. Date: Mar. 26, 2009

(54) Liquid Container and Liquid Injection Device

(75) Inventor: Hitotoshi KIMURA, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/210,857

(22) Filed: Sep. 15, 2008

(30) Foreign Application Priority Data
Sep. 21, 2007 (JP) 2007-245486

(51) Int. Cl. B41J 2/175

(52) U.S. Cl. 347/86

(57) ABSTRACT

A liquid container is constructed to store a liquid and supply the liquid to a liquid injection device in response to inflow of a pressurized fluid from the liquid injection device. The liquid container comprises: a flow inlet formed to allow the pressurized fluid to be flowed in from the liquid injection device; a liquid reservoir formed to store the liquid therein; a supply inlet formed to connect with the liquid reservoir and supply the liquid, which is flowed out of the liquid reservoir in response to the inflow of the pressurized fluid, to the liquid injection device; and a pressure detector that identifies a pressure status of the pressurized fluid flowed in from the liquid injection device. The liquid container of this structure enables easy determination of whether the pressurized fluid is normally supplied to the liquid container.

### CROSS-REFERENCE TO RELATED APPLICATION

The present application claims the priority based on Japanese Patent Application No. 2007-245486 filed on Sep. 21, 2007, the disclosure of which is hereby incorporated by reference in its entirety.

### BACKGROUND

1. Technical Field

The present invention relates to a liquid injection device and a technique of detecting an abnormality occurring in a liquid container used to supply a liquid to the liquid injection device.

2. Related Art

A liquid injection device provided in an inkjet recording apparatus, an inkjet printing apparatus, or a microdispenser receives a supply of liquid, such as ink, from a liquid container and injects the supplied liquid. One known technique feeds the air pressurized by a pump to the liquid container to accelerate the supply of the liquid to the liquid injection device (see, for example, JP-A-2001-253084 and JP-A-2002-52737).

The inkjet recording apparatus disclosed in JP-A-2001-253084 has a pressure pump configured to pressurize the air and a pressure detector configured to detect the pressure of the pressurized air. The occurrence or non-occurrence of an abnormality in an air supply system is identifiable according to the pressure of the pressurized air detected by the pressure detector.

In the case of abnormality detection using only the pressure detector provided in the main body (inkjet recording apparatus), however, it is difficult to identify whether the abnormality occurs in the main body or in the liquid container. In the inkjet recording apparatus having the supplies of inks from multiple liquid containers, it is also difficult to identify which of the multiple liquid containers has an abnormality.

### SUMMARY

By taking into account such drawbacks of the prior art, there would be a demand for enabling easy determination of whether the pressurized air is normally supplied to a liquid container, which is constructed to supply a liquid to a liquid injection device in response to inflow of the pressurized air from the liquid injection device.

The present invention accomplishes at least part of the demand mentioned above and the other relevant demands by the following configuration applied to the liquid container.

An aspect of the invention is directed to a liquid container designed to store a liquid to be supplied to a liquid injection device. The liquid container comprises: a flow inlet formed to allow a pressurized fluid to be flowed in from the liquid injection device; a liquid reservoir formed to store the liquid therein; a supply inlet formed to connect with the liquid reservoir and supply the liquid, which is flowed out of the liquid reservoir in response to inflow of the pressurized fluid, to the liquid injection device; and a pressure detector that identifies a pressure status of the pressurized fluid flowed in from the liquid injection device.

The liquid container according to this aspect of the invention has the pressure detector to identify the pressure status of the pressurized fluid flowed in from the liquid injection device. The use of this pressure detector enables easy determination of whether the pressurized fluid is normally supplied to the liquid container. In attachment of multiple liquid containers to the liquid injection device, this arrangement of the invention enables easy determination of whether the pressurized fluid is normally supplied to each of the multiple liquid containers. The pressure status of the pressurized fluid identified by the pressure detector may be showed on a display unit, such as an LED, provided in the liquid container.

In one preferable embodiment of the liquid container according to the above aspect of the invention, at least part of the liquid reservoir is made of a flexible member. The pressure detector detects deformation of the flexible member to identify the pressure status of the pressurized fluid flowed in from the liquid injection device. In the liquid container of this arrangement, the normal supply of the pressurized fluid to the liquid container is readily determinable by simply detecting deformation of the flexible member caused by the inflow of the pressurized fluid.

In another preferable embodiment of the invention, the liquid container further comprises: a flow path arranged to connect the flow inlet with the liquid reservoir; and a pressure detection chamber formed to temporarily store the pressurized fluid flowing through the flow path. At least part of the pressure detection chamber is made of a flexible member. The pressure detector detects deformation of the flexible member to identify the pressure status of the pressurized fluid flowed in from the liquid injection device. In the liquid container of this arrangement, the normal supply of the pressurized fluid to the liquid container is readily determinable by simply detecting deformation of the flexible member caused by the inflow of the pressurized fluid.

The liquid container of either of the above embodiments may further comprises a pressing member arranged to press the flexible member in a direction against pressure of the pressurized fluid. In the liquid container of this arrangement, the pressure status of the pressurized fluid is identified with high accuracy by simply detecting deformation of the flexible member in a direction opposite to a pressing direction of the pressing member.

In one preferable application of the invention, the liquid container having any of the above arrangements further comprises: an electrically conductive member provided in part of the flexible member; and an electrode arranged to have a contact or non-contact with the electrically conductive member according to deformation of the flexible member. The pressure detector detects a conductive state of the electrically conductive member with the electrode to identify the pressure status of the pressurized fluid flowed in from the liquid injection device. In the liquid container of this arrangement, the pressure status of the pressurized fluid is readily identified by simply detecting the conductive state of the electrically conductive member with the electrode.

In another preferable application of the invention, the liquid reservoir has a flexible liquid vessel located inside the liquid reservoir and formed to store the liquid therein. The flow inlet communicates with a space defined by the liquid reservoir and the liquid vessel. The supply inlet communicates with the liquid vessel located in the liquid reservoir. In the liquid container of this arrangement, the pressurized fluid is not directly in contact with the liquid kept in the liquid vessel. This arrangement thus desirably keeps the liquid in the favorable storage condition.

In still another preferable application of the invention, the liquid container having any of the above arrangements further comprises a signal output module that outputs a signal representing the identified pressure status to the liquid injection device. This arrangement enables the liquid injection device to detect an abnormal supply of the pressurized fluid to the liquid container according to the signal input from the signal output module of the liquid container.

The present invention also accomplishes at least part of the above demand by the following configuration applied to the liquid injection device.

According to another aspect, the invention is also directed to a liquid injection device constructed to enable attachment of the liquid container having any of the above arrangements. The liquid injection device comprises: a pressurized fluid supplier that supplies the pressurized fluid to the liquid container; and an injector that injects the liquid supplied from the liquid container.

In one preferable embodiment of the invention, the liquid injection device further comprises an abnormality detection module refers to the signal input from the signal output module of the liquid container and determines whether the pressurized fluid is normally supplied to the liquid container. The liquid injection device of this arrangement uses the signal input from the liquid container to readily detect the normal supply of the pressurized fluid.

In one preferable application, the liquid injection device of the above embodiment further comprises a pressure sensor that measures a pressure of the pressurized fluid supplied from the pressurized fluid supplier to the liquid container. The abnormality detection module identifies a location of an abnormality, based on the signal input from the signal output module of the liquid container and the pressure of the pressurized fluid measured by the pressure sensor. The location of the abnormality is identifiable by detecting the pressure statuses of the pressurized fluid in both the liquid container and the liquid injection device.

In the liquid injection device of the above application, it is preferable that the abnormality detection module refers to a predetermined table specifying abnormality occurrence places according to combinations of a pressure status of the pressurized fluid in the liquid container and a pressure status of the pressurized fluid in the liquid injection device, and identifies the location of the abnormality. The liquid injection device of this arrangement enables easy identification of the location of the abnormality by simply referring to the table.

In one preferable embodiment of the liquid injection device, the liquid container further comprises a non-volatile storage unit, and the abnormality detection module writes a result of the determination into the storage unit. The result of abnormality detection is written into the storage unit of the liquid container. This enables efficient collection of information representing the frequency of the occurrence of abnormalities and the place of an abnormality in the course of collection of the used liquid container.

The technique of the invention is not restricted to the liquid container or the liquid injection device having any of the arrangements described above but may also be applied to an abnormality detection method for the liquid container and a computer program executed for abnormality detection. The computer program may be recorded in a computer readable recording medium. Typical examples of the recording medium include flexible disks, CD-ROMs, DVD-ROMs, magneto-optical disks, memory cards, and hard disks.

These and other objects, features, aspects, and advantages of the invention will become more apparent from the following detailed description of the preferred embodiments with the accompanying drawings.

### BRIEF DESCRIPTION OF THE DRAWINGS

FIG. 1 schematically illustrates the configuration of an inkjet recording apparatus in one embodiment of the invention;

FIG. 2 is a sectional view showing the internal structure of a liquid container in a first embodiment of the invention;

FIG. 3 is a flowchart showing an abnormality detection process;

FIG. 4 is a sectional view showing a liquid container in a second embodiment of the invention;

FIG. 5 is a sectional view showing a liquid container in a third embodiment of the invention;

FIG. 6 is a sectional view showing a liquid container in a fourth embodiment of the invention;

FIG. 7 shows another application of a pressure detector; and

FIG. 8 shows still another application of the pressure detector.

### DESCRIPTION OF THE PREFERRED EMBODIMENTS

Some modes of carrying out the invention are described below in the following sequence:
A. First Embodiment

(A1) General Configuration of Inkjet Recording Apparatus

(A2) Detailed Structure of Liquid Container

(A3) Abnormality Detection Process
B. Second Embodiment
C. Third Embodiment
D. Fourth Embodiment
E. Modifications

### A. First Embodiment

### (A1) General Configuration of Inject Recording Apparatus

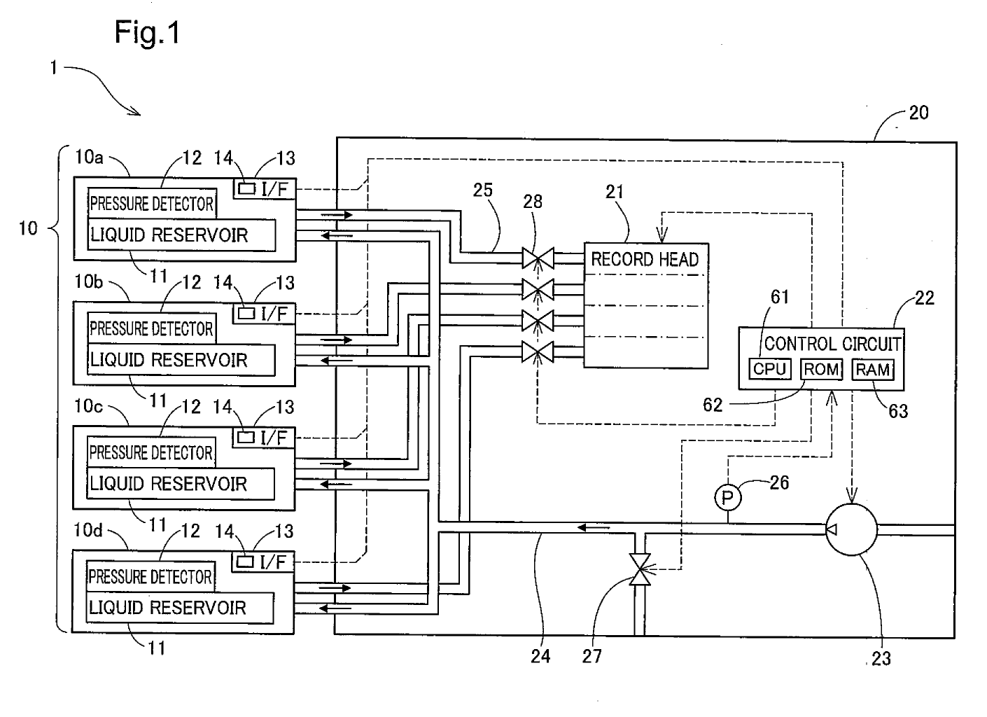

FIG. 1 schematically illustrates the configuration of an inkjet recording apparatus 1 in one embodiment of the invention. The inkjet recording apparatus 1 has liquid containers 10a to 10d and a liquid injection device 20. The liquid injection device 20 of the embodiment is designed to eject ink from a record head 21 onto a recording medium and thereby print images and strings of letters or characters. The liquid containers 10a to 10d are ink cartridges detachably attached to a container attachment of the liquid injection device 20 to supply respective inks to the record head 21 of the liquid injection device 20.

The four liquid containers 10a to 10d respectively storing inks of cyan, magenta, yellow, and black therein are attached to the liquid injection device 20 of the embodiment. These four liquid containers 10a to 10d have an identical structure and are collectively referred to as the liquid container 10 in the description below. Instead of the four liquid containers 10 for the four different color inks attached to the liquid injection device 20 of the embodiment for color printing, only one liquid container 10 for black ink may be attached to the liquid injection device for monochromatic printing. Additional liquid containers 10 storing different color inks, for example, light cyan and light magenta, may further be attached to the liquid injection device for printing with a greater number of color inks.

As shown in FIG. 1, the liquid container 10 has a liquid reservoir 11, a pressure detector 12, and an interface board 13. The liquid reservoir 11 stores ink to be supplied to the liquid injection device 20. The pressure detector 12 is a sensor designed to detect a pressure condition of the pressurized air supplied from the liquid injection device 20 to the liquid container 10.

The interface board 13 has terminals to electrically connect the pressure detector 12 with a control circuit 22 of the liquid injection device 20 in attachment of the liquid container 10 to the liquid injection device 20. The interface board 13 further has an EEPROM 14 as a non-volatile storage memory. Pieces of information regarding the manufacturer ID, the model number, the serial number, and the date of manufacture are recorded in the EEPROM 14. In attachment of the liquid container 10 to the liquid injection device 20, an input-output port of the EEPROM 14 is also connected with the control circuit 22 of the liquid injection device 20 via the interface board 13. The interface board 13 may have a wireless communication circuit to make wireless communication with the control circuit 22.

As illustrated, the liquid injection device 20 has a pressure pump 23 used to pressurize the air, an air flow path 24 arranged to supply the flow of the pressurized air to the liquid container 10, ink flow paths 25 arranged to introduce the supplies of inks from the respective liquid containers 10 to the record head 21, the record head 21 configured to eject the supplies of inks flowed through the respective ink flow paths 25 onto a recording medium, and the control circuit 22 configured to control ejection of ink from the record head 21.

The control circuit 22 has a CPU 61, a ROM 62, and a RAM 63. The CPU 61 loads a control program recorded in the ROM 62 onto the RAM 63 and executes the control program to perform ejection control of ink from the record head 21 and abnormality detection (discussed later).

The air flow path 24 is arranged to supply the flow of the air, which is pressurized to the higher pressure than the atmospheric pressure by the pressure pump 23, to the liquid container 10. The air flow path 24 is equipped with a pressure sensor 26 and an air release valve 27. The air flow path 24 has four branch flow paths, which are respectively connected in parallel to the liquid containers 10a to 10d. In the structure of this embodiment, the pressurized air is used as the pressurized fluid. The pressurized air is, however, neither essential nor restrictive. Another gas or a suitable liquid unmixable with ink may be pressurized and supplied to the liquid container 10.

The pressure sensor 26 and the air release valve 27 are connected to the control circuit 22. The control circuit 22 controls the pressure sensor 26 to measure the pressure of the air flow in the air flow path 24 and performs feedback control S of the pressure pump 23 according to the measured pressure. Such feedback control adequately adjusts the pressure of the pressurized air to ensure optimum ejection of ink from the record head 21 of the liquid injection device 20. The control circuit 22 identifies a ‘high’ pressure condition when the pressure of the pressurized air measured by the pressure sensor 26 is higher than a preset reference pressure, while identifying a ‘low’ pressure condition when the measured pressure of the pressurized air is lower than a preset threshold pressure.

The ink flow paths 25 are arranged to introduce the supplies of inks from the respective liquid containers 10a to 10d to the record head 21. The record head 21 has four groups of nozzles corresponding to the four color inks. The four groups of nozzles have one-to-one connection with the corresponding liquid containers 10a to 10d. Each of the ink flow paths 25 is equipped with an on-off valve 28. The on-off valve 28 is closed by the control circuit 22, for example, in response to a power off operation of the liquid injection device 20 or in response to detachment of the liquid container 10 from the liquid injection device 20. A check valve may be adopted for the on-off valve 28.

### (A2) Detailed Structure of Liquid Container

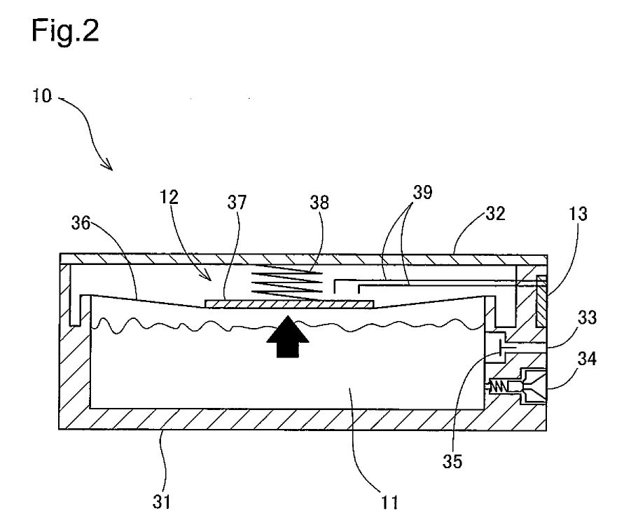

FIG. 2 is a sectional view showing the internal structure of the liquid container 10. As illustrated, the liquid container 10 has a casing 31 and a cover member 32 arranged to cover the top of the casing 31 and internally includes the pressure detector 12 and the liquid reservoir 11. The liquid reservoir 11 keeps ink therein. The casing 31 has an air flow inlet 33 and a liquid supply inlet 34 communicating with the liquid reservoir 11.

The air flow inlet 33 is connected with the air flow path 24 shown in FIG. 1. The pressurized air supplied from the air flow path 24 goes through the air flow inlet 33 and flows into the liquid reservoir 11. The air flow inlet 33 is equipped with a check valve 35, which prevents ink from flowing from the liquid reservoir 11 into the air flow path 24.

The liquid supply inlet 34 is connected with the ink flow path 25 shown in FIG. 1. The pressurized air entering the liquid reservoir 11 presses the ink kept in the liquid reservoir 11 out of the liquid supply inlet 34. The ink then flows through the ink flow path 25 and is fed to the record head 21 of the liquid injection device 20. The liquid supply inlet 34 has a leakage proof mechanism to prevent ink from leaking out in detachment of the liquid container 10 from the liquid injection device 20.

The pressure detector 12 has a flexible film member 36 provided on the top face of the liquid reservoir 11, a pressure receiving plate 37, a pressure regulator spring 38, and two electrodes 39.

The electrically-conductive pressure receiving plate 37 is located on the center of the film member 36 provided on the top face of the liquid reservoir 11. The pressure regulator spring 38 is located between the pressure receiving plate 37 and the cover member 32 to press the pressure receiving plate 37 and the film member 36 in a direction of reducing the volume of the liquid reservoir 11 (that is, in a direction against the pressurized fluid). The two electrodes 39 are connected with the interface board 13 and are extended over the pressure receiving plate 37. These electrodes 39 are arranged to have their respective ends face the pressure receiving plate 37.

In the state of no inflow of the pressurized air into the liquid reservoir 11, the pressing force of the pressure regulator spring 38 presses down both the pressure receiving plate 37 and the film member 36 toward the liquid reservoir 11. In this state, the electrically-conductive pressure receiving plate 37 is not in contact with the two electrodes 39. Namely the two electrodes 39 are not electrically conductive.

In the state of inflow of the pressurized air into the liquid reservoir 11, on the other hand, the force of the pressurized air presses up both the film member 36 and the pressure receiving plate 37 against the pressing force of the pressure regulator spring 38 to be deformed (see the arrow in FIG. 2). In this state, the electrically-conductive pressure receiving plate 37 is in contact with the two electrodes 39. Namely the two electrodes 39 are electrically conductive.

The control circuit 22 of the liquid injection device 20 makes the electric current flow through the electrodes 39. And the control circuit 22 detects the electrical conduction state of the electrodes 39 to identify the pressure status of the pressurized air supplied to the liquid container 10, that is, the state of inflow of the pressurized air. In response to application of a preset voltage to one of the electrodes by the control circuit 22, the other electrode outputs either a high voltage signal or a low voltage signal as a signal representing the pressure status of the pressurized air. The high voltage signal output from the liquid container 10 indicates a higher pressure of the pressurized air than the preset pressure. The low voltage signal output from the liquid container 10 indicates a lower pressure of the pressurized air than the preset pressure. The ‘preset pressure’ may be changed adequately by regulating the pressing force of the pressure regulator spring 38.

### (A3) Abnormality Detection Process

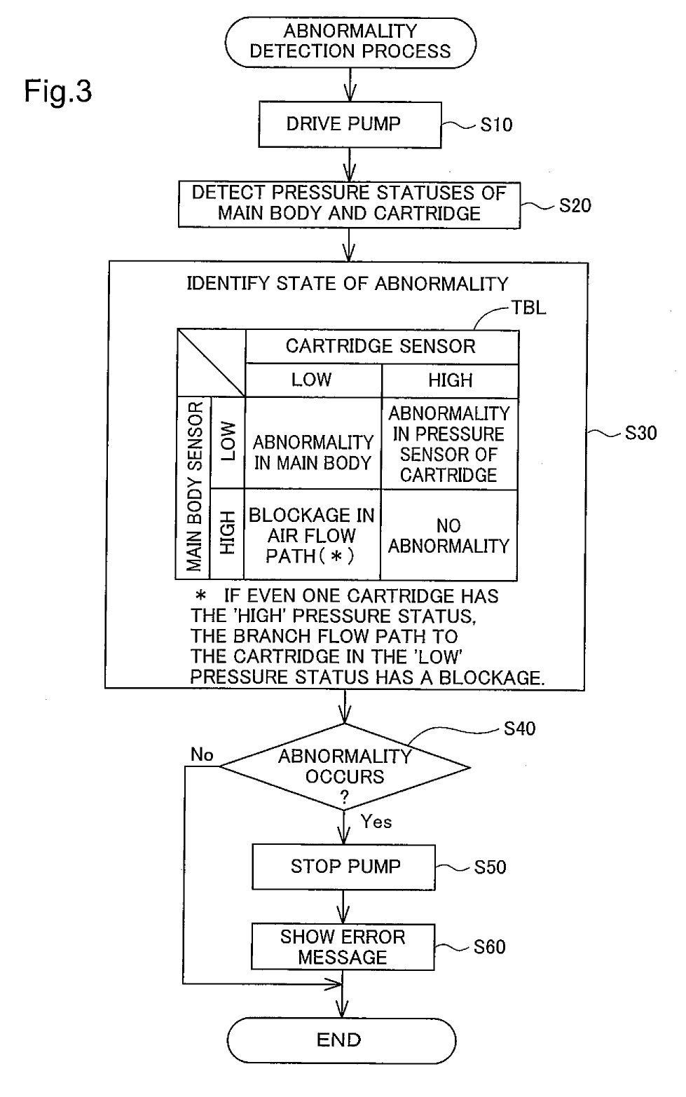

FIG. 3 is a flowchart showing an abnormality detection process executed by the control circuit 22 in the liquid injection device 20. The abnormality detection process is performed, for example, in response to a power-on operation of the liquid injection device 20 in the state of attachment of the liquid containers 10 to the liquid injection device 20.

In the abnormality detection process, the control circuit 22 first drives the pressure pump 23 to supply the pressurized air to the respective liquid containers 10a to 10d (step S10). The control circuit 22 controls the pressure sensor 26 provided in the air flow path 24 of the liquid injection device 20 (hereafter may be referred to as the ‘main body’) and the pressure detectors 12 provided in the respective liquid containers 10a to 10d (hereafter may be referred to as the ‘cartridge’) to detects the pressure statuses of the main body and the cartridge (step S20).

After detection of the pressure statuses of the main body and the cartridge, the control circuit 22 refers to an abnormality detection table TBL stored in the ROM 62 to identify the state of abnormality in the air supply system according to the combination of the pressure statuses of the main body and the cartridge (step S30). A function or a conditional expression may be used to identify the state of abnormality, in place of the abnormality detection table TBL used in this embodiment.

One example of the abnormality detection table TBL is also shown in FIG. 3. The abnormality detection table TBL specifies four abnormality detection results corresponding to the combinations of the pressure status (‘high’ or ‘low’) detected by the pressure sensor 26 of the main body and the pressure status (‘high’ or ‘low’) detected by the pressure detector 12 of the cartridge.

According to the abnormality detection table TBL shown in FIG. 3, the combination of the ‘high’ pressure status of the main body and the ‘high’ pressure status of the cartridge specifies no abnormality. In this state, it is expected that the air is normally pressurized and is supplied to the liquid reservoirs 11 of all the cartridges.

The combination of the ‘low’ pressure status of the main body and the ‘low’ pressure status of the cartridge specifies an abnormality occurring in the main body. In this state, it is expected that the occurrence of an abnormality in the pressure pump 23 or the air release valve 27 causes failed pressurization of the air.

The combination of the ‘low’ pressure status of the main body and the ‘high’ pressure status of the cartridge specifies an abnormality occurring in the cartridges. In the low pressure state of the main body, it is unlikely to have the high pressure in the cartridge. In this state, it is thus expected that an abnormality occurs in the pressure detector 12 of the cartridge.

The combination of the ‘high’ pressure status of the main body and the ‘low’ pressure status of the cartridge specifies blockage in the air flow path 24 from the main body to the liquid reservoir 11 of the cartridge. The ‘high’ pressure status of the main body means normal pressurization of the air. If even one of the cartridges has the ‘high’ pressure status, it is determined that the air flow path (the branch flow path) to the cartridge in the ‘low’ pressure status has a blockage.

When the state of abnormality identified at step S30 represents the occurrence of an abnormality (step S40: yes), the control circuit 22 stops the operation of the pressure pump 23 driven at step S10 (step S50). The control circuit 22 then shows a preset error message representing the occurrence of an abnormality on a display unit of the liquid injection device 20 (step S60). The occurrence of an abnormality may be informed by an audio alarm or may be notified to another device (for example, a printer server) via a network. The control circuit 22 may record information representing the occurrence of an abnormality into the EEPROM 14 provided in the liquid container 10. This enables efficient collection of information representing the frequency of the occurrence of abnormalities and the place of an abnormality in the course of collection of the used liquid containers 10.

When the state of abnormality identified at step S30 represents no occurrence of an abnormality (step S40: no), on the other hand, the control circuit 22 keeps the pressure pump 23 driven and terminates the abnormality detection process. After termination of the abnormality detection process, a printing operation or another required operation is performed.

As described above, the inkjet recording apparatus 1 of the embodiment has the sensors for detecting the pressure status of the pressurized air in both the liquid containers 10 and the liquid injection device 20 (the pressure detectors 12 and the pressure sensor 26). These sensors are used to detect the pressure statuses in both the liquid containers 10 and the liquid injection device 20 and enable easy identification of the place of an abnormality.

In the structure of the first embodiment, all the liquid containers 10 attached to the liquid injection device 20 respectively have the pressure detectors 12. This structure enables individual abnormality detection for each liquid container 10.

The pressure detector 12 provided in the liquid container 10 of the embodiment has the electrically-conductive pressure receiving plate 37 located on the center of the flexible film member 36. The pressure status of the pressurized air is detected by contact or non-contact of the electrically-conductive pressure receiving plate 37 with the two electrodes 39. The pressure detector 12 of this structure does not require a power supply circuit or any complicated wiring, thus desirably simplifying the structure of the liquid container 10.

### B. Second Embodiment

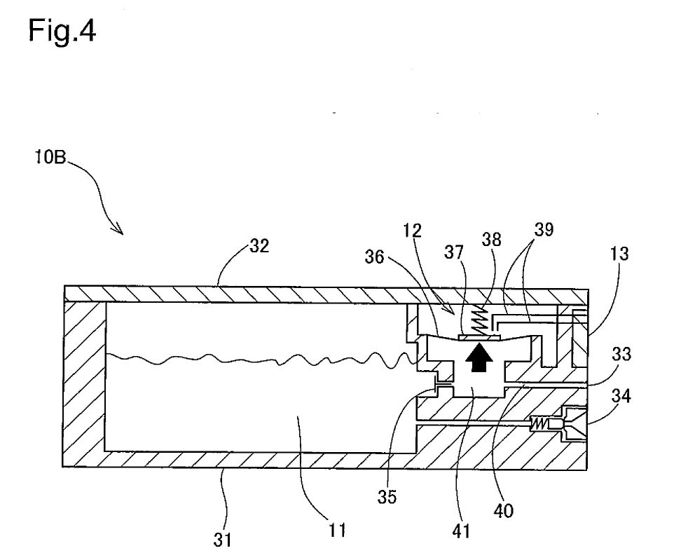

FIG. 4 is a sectional view showing a liquid container 10B in a second embodiment of the invention. In the liquid container 10B of the second embodiment shown in FIG. 4, the like elements to those of the liquid container 10 of the first embodiment shown in FIG. 2 are expressed by the like numerals. The liquid container 10 of the first embodiment has the flexible film member 36 provided on the top face of the liquid reservoir 11 to integrate the liquid reservoir 11 with the pressure detector 12. In the structure of the second embodiment, on the other hand, a liquid reservoir 11 is independently formed in the liquid container 10B. A pressure detector 12 is placed in an air conduit 40 connecting the liquid reservoir 11 with an air flow inlet 33. A check valve 35 is provided between the pressure detector 12 and the liquid reservoir 11 to prevent ink leakage through the air conduit 40.

The pressure detector 12 of the embodiment has a pressure detection chamber 41 where the pressurized air flowed in through the air flow inlet 33 is temporarily stored. A flexible film member 36 is provided on the top face of the pressure detection chamber 41, and an electrically-conductive pressure receiving plate 37 is located on the center of the film member 36. A pressure regulator spring 38 is located between the pressure receiving plate 37 and a cover member 32. Two electrodes 39 extended from an interface board 13 are arranged above the pressure receiving plate 37.

In the liquid container 10B of the second embodiment, the pressure detection chamber 41 is provided independently of the liquid reservoir 11 and is thus easily assembled with high accuracy. The pressure detection chamber 41 has a small volume. This enables size reduction and shortens the distance to the interface board 13, thus desirably reducing the manufacturing cost.

### C. Third Embodiment

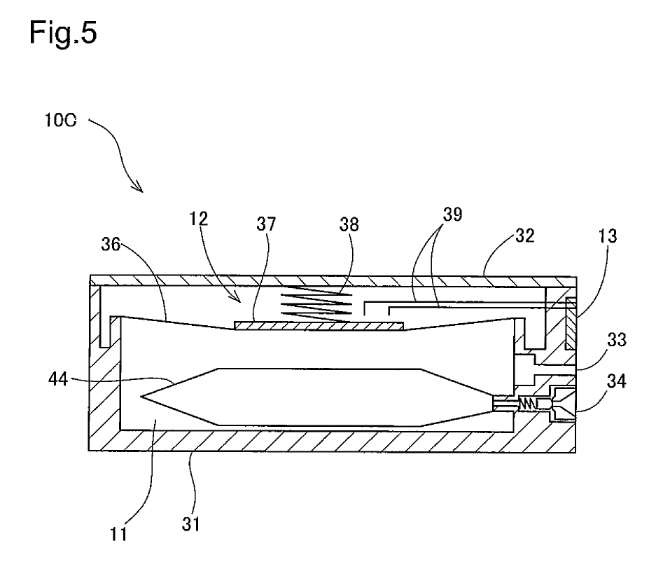

FIG. 5 is a sectional view showing a liquid container 10C in a third embodiment of the invention. The liquid container 10C of the third embodiment shown in FIG. 5 has the similar structure to that of the liquid container 10 of the first embodiment shown in FIG. 2, except a flexible ink pack 44 provided in the liquid reservoir 11. The ink pack 44 is filled with ink in a liquid tight condition. The ink pack 44 is formed by bonding the peripheries of two aluminum laminate films. Each aluminum laminate film is formed as a laminate of a flexible resin film layer and an aluminum layer. One end of the ink pack 44 is connected with a liquid supply inlet 34. Ink is supplied from the liquid supply inlet 34 to the record head 21 of the ink injection device 20.

In the liquid container 10C of the third embodiment, an air flow inlet 33 communicates with an enclosed space in the liquid reservoir 11 defined by the ink pack 44, a casing 31, and a film member 36. When the pressurized air flows into this enclosed space, the pressure of the pressurized air contracts the ink pack 44 and makes ink flow out of the liquid supply inlet 34. The inflow of the pressurized air into this enclosed space also presses up both the film member 36 and a pressure receiving plate 37.

In the liquid container 10C of the third embodiment, the pressurized air supplied from the liquid injection device 20 is not directly in contact with ink. This arrangement desirably keeps ink in the good storage condition. The liquid container 10 of the first embodiment has the check valve 35 to prevent ink leakage through the air flow inlet 33. The liquid container 10C of the third embodiment, however, does not require the check valve 35 since there is no ink leakage through the air flow inlet 33.

### D. Fourth Embodiment

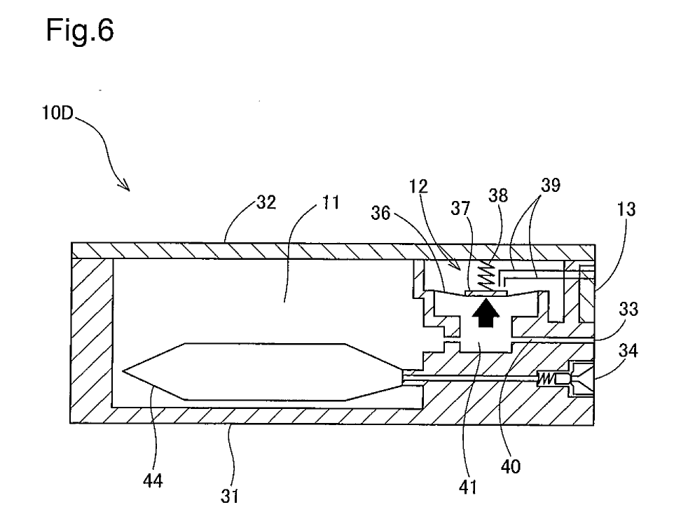

FIG. 6 is a sectional view showing a liquid container 10D in a fourth embodiment of the invention. The liquid container 10D of the third embodiment shown in FIG. 6 basically has the similar structure to that of the liquid container 10B of the second embodiment shown in FIG. 4. Namely the pressure detector 12 is provided separately from the liquid reservoir 11. In the liquid container 10D of the fourth embodiment, ink is kept in an ink pack 44 as in the structure of the liquid container 10C of the third embodiment. The liquid container 10D of the fourth embodiment accordingly has the advantages of the structures of the second embodiment and the third embodiment.

### E. Modifications

The embodiments and their applications discussed above are to be considered in all aspects as illustrative and not restrictive. There may be many modifications, changes, and alterations without departing from the scope or spirit of the main characteristics of the present invention. Some possible modifications are given below.

### (E1) Modification 1

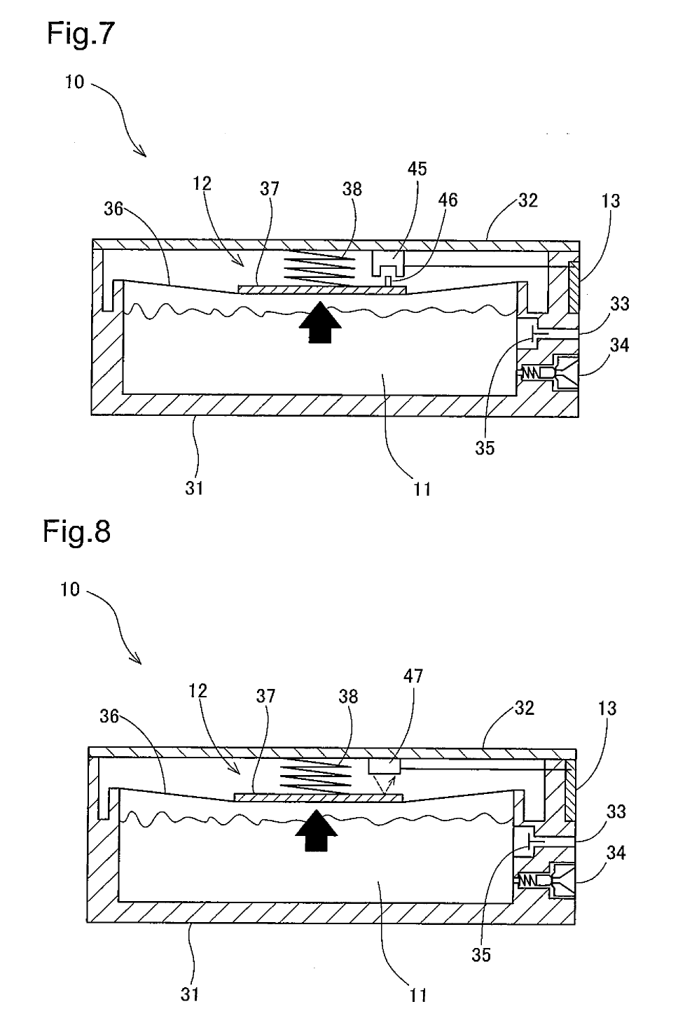

FIGS. 7 and 8 show other applications of the pressure detector 12. In the structures of the embodiments described above, the electrically-conductive pressure receiving plate 37 is located on the center of the flexible film member 36. The pressure status of the pressurized air is detected by contact or non-contact of the electrically-conductive pressure receiving plate 37 with the two electrodes 39. In another application of the pressure detector 12 shown in FIG. 7, a transmission-type photo sensor 45 is fastened to the lower side of the cover member 32. A light shield 46 is provided on the pressure receiving plate 37 to shield light in a slit formed in the photo sensor 45. In still another application of the pressure detector 12 shown in FIG. 8, a reflection-type photo sensor 47 is fastened to the lower side of the cover member 32. The light reflected from the pressure receiving plate 37 is received by the reflection-type photo sensor 47. These modified structures also enable detection of a displacement of the flexible film member 36 and the pressure receiving plate 37 caused by the inflow of the pressurized air. In the application of the pressure detector 12 with the photo sensor, the pressure receiving plate 37 may not be electrically conductive. Another application may provide a semiconductor pressure sensor in the air flow path of the liquid container 10 to detect the pressure status of the pressurized air.

### (E2) Modification 2

In the structures of the embodiments described above, the main body has the pressure sensor 26. The pressure sensor 26 of the main body may, however, be omitted, and only the pressure detectors 12 of the cartridges may be used for abnormality detection. This modified structure enables detection of the occurrence of an abnormality in the air supply system. On the assumption of no abnormality in the main body, this modified structure enables identification of the liquid container 10 having an abnormality among the multiple liquid containers 10.

### (E3) Modification 3

In the embodiments described above, the control circuit 22 of the liquid injection device 20 identifies the conductive condition of the two electrodes 39 and the electrically-conductive pressure receiving plate 37 provided in the liquid container 10 via the interface board 13 to detect the pressure status of the pressurized air. Namely the liquid injection device 20 mainly works to detect the pressure status of the pressurized air supplied to the liquid container 10. In one modified structure, the liquid container 10 may have a circuit of measuring the pressure of the pressurized air and mainly work to detect the pressure status of the pressurized air supplied thereto. The liquid container 10 may also identify an abnormality occurring therein, in addition to detection of the pressure status of the pressurized air. The result of abnormality detection may be transmitted to the liquid injection device 20 via the interface board 13. The liquid container 10 may have a display unit, such as an LED, to inform the user of the occurrence of an abnormality.

### (E4) Modification 4

In the structures of the embodiments described above, all the liquid containers 10 attached to the liquid injection device 20 have the pressure detectors 12. In one modified structure, only part of the liquid containers 10 attached to the liquid injection device 20 may have a pressure detector 12. In this modification, it is preferable that information representing the presence or the absence of a pressure detector 12 is recorded in the EEPROM 14 of each liquid container 10. The control circuit 22 of the liquid injection device 20 reads this information from the EEPROM 14 of each liquid container 10 and changes the processing flow of abnormality detection according to the presence or the absence of the pressure detector 12 of the liquid container 10. The control circuit 22 performs the abnormality detection described in the first embodiment for the liquid container 10 equipped with the pressure detector 12, while using only the pressure sensor 26 of the main body to detect the occurrence of an abnormality for the liquid container 10 without the pressure detector 12.

### (E5) Modification 5

In the embodiments described above, the control circuit 22 of the liquid injection device 20 detects the occurrence of an abnormality. In another application, the liquid container 10 may be designed to enable deformation of the film member 36 to be visually recognized. This modified arrangement enables the user to detect the occurrence of an abnormality.

### (E6) Modification 6

In the embodiments described above, the liquid containers 10 are attached to the inkjet recording apparatus 1. The liquid container 10 is, however, not restrictively attached to the inkjet recording apparatus 1 but may be attached to diversity of other devices, for example, a device equipped with a color material injection head used for manufacturing color filters of liquid crystal displays, a device equipped with an electrode material (conductive paste) injection head used for manufacturing electrodes of organic EL displays and face emitting displays (FED), a device equipped with a bioorganic material injection head used for manufacturing biochips, a device equipped with a sample injection head used as a precision pipette, a printing device, and a microdispenser.

What is claimed is:

1. A liquid container designed to store a liquid to be supplied to a liquid injection device, the liquid container comprising:
a flow inlet formed to allow a pressurized fluid to be flowed in from the liquid injection device;
a liquid reservoir formed to store the liquid therein;
a supply inlet formed to connect with the liquid reservoir and supply the liquid, which is flowed out of the liquid reservoir in response to inflow of the pressurized fluid, to the liquid injection device; and
a pressure detector that identifies a pressure status of the pressurized fluid flowed in from the liquid injection device.

2. The liquid container in accordance with claim 1, wherein at least part of the liquid reservoir is made of a flexible member, and
the pressure detector detects deformation of the flexible member to identify the pressure status of the pressurized fluid flowed in from the liquid injection device.

3. The liquid container in accordance with claim 2, the liquid container further comprising:
a pressing member arranged to press the flexible member in a direction against pressure of the pressurized fluid.

4. The liquid container in accordance with claim 1, the liquid container further comprising:
a flow path arranged to connect the flow inlet with the liquid reservoir; and
a pressure detection chamber formed to temporarily store the pressurized fluid flowing through the flow path,
wherein at least part of the pressure detection chamber is made of a flexible member, and
the pressure detector detects deformation of the flexible member to identify the pressure status of the pressurized fluid flowed in from the liquid injection device.

5. The liquid container in accordance with claim 4, the liquid container further comprising:
a pressing member arranged to press the flexible member in a direction against pressure of the pressurized fluid.

6. The liquid container in accordance with claim 2, the liquid container further comprising:
an electrically conductive member provided in part of the flexible member; and
an electrode arranged to have a contact or non-contact with the electrically conductive member according to deformation of the flexible member,
wherein the pressure detector detects a conductive state of the electrically conductive member with the electrode to identify the pressure status of the pressurized fluid flowed in from the liquid injection device.

7. The liquid container in accordance with claim 1, wherein the liquid reservoir has a flexible liquid vessel located inside the liquid reservoir and formed to store the liquid therein,
the flow inlet communicates with a space defined by the liquid reservoir and the liquid vessel, and
the supply inlet communicates with the liquid vessel located in the liquid reservoir.

8. The liquid container in accordance with claim 1, the liquid container further comprising:
a signal output module that outputs a signal representing the identified pressure status to the liquid injection device.

9. A liquid injection device constructed to enable attachment of the liquid container in accordance with claim 8,
the liquid injection device comprising:
a pressurized fluid supplier that supplies the pressurized fluid to the liquid container; and
an injector that injects the liquid supplied from the liquid container.

10. The liquid injection device in accordance with claim 9, the liquid injection device further comprising:
an abnormality detection module that refers to the signal input from the signal output module of the liquid container and determines whether the pressurized fluid is normally supplied to the liquid container.

11. The liquid injection device in accordance with claim 10, the liquid injection device further comprising:
a pressure sensor that measures a pressure of the pressurized fluid supplied from the pressurized fluid supplier to the liquid container,
wherein the abnormality detection module identifies a location of an abnormality, based on the signal input from the signal output module of the liquid container and the pressure of the pressurized fluid measured by the pressure sensor.

12. The liquid injection device in accordance with claim 11, wherein the abnormality detection module refers to a predetermined table specifying abnormality occurrence places according to combinations of a pressure status of the pressurized fluid in the liquid container and a pressure status of the pressurized fluid in the liquid injection device, and identifies the location of the abnormality.

13. The liquid injection device in accordance with claim 10, wherein the liquid container further comprises a non-volatile storage unit, and
the abnormality detection module writes a result of the determination into the storage unit.
